(19) United States
(12) Patent Application Publication
(10) Pub. No.: US 2002/0049658 A1
(43) Pub. Date: Apr. 25, 2002

(54) Ticket remarketing system and method

(76) Inventors: George Davidson, Calgary (CA); Robert Christianson, Calgary (CA); Clark Johannson, Calgary (CA); Brendan Duddridge, Calgary (CA)

Correspondence Address: BENNETT JONES, C/O MS ROSEANN CALDWELL, 4500 BANKERS HALL EAST, 855 - 2ND STREET, SW, CALGARY, AB, T2P 4K7, CA

(21) Appl. No.: 09/682,394

(22) Filed: Aug. 29, 2001

Related U.S. Application Data
(60) Provisional application No. 60/228,412, filed on Aug. 29, 2000.

(51) Int. Cl. G06F 17/60

(52) U.S. Cl. 705/37

(57) ABSTRACT

A method for using a computer network to facilitate the resale of season tickets. Using this method, both prospective buyers and prospective sellers may post offers to buy or offers to sell as well as accept offers to sell and offers to buy. In each case credit card accounts of those posting offers are authorized when the offers are posted; in the case of offers to buy, authorization is obtained for offering price and a transaction charge, and in the case of offers to sell, authorization is obtained for a ticket pickup courier charge.

### CROSS REFERENCE TO RELATED APPLICATIONS

The present application claims the benefit of U.S. Provisional Application No. 60/228,412 filed Aug. 29, 2000, which application is hereby incorporated herein by reference in its entirety including its drawings.

### BACKGROUND OF INVENTION

The present invention is in the area of marketing of season tickets events, and in particular, in the area of remarketing of season tickets.

In the past, holders of season tickets have been presented with a problem when they are unable to use their season tickets for a particular event. There has been no convenient facility allowing them to resell such tickets. In many cases the tickets go unused or are given away.

### SUMMARY OF INVENTION

In one aspect the invention provides a computer-based system and method by which tickets, particularly unused season tickets, to events such as sporting and cultural events may be resold using a communication system such as the Internet. In the attached drawings and the following discussion, a “User” is a prospective seller or buyer of a season ticket. An “Internal User” is an employee of the operator of the system. A “Venue” is the entity that issued the season ticket, such as the home team in the case of a sporting event. As well, the system and method may be applied to tickets to a series of cultural events, such as a concert series by an orchestra, ballet, or opera or a series of plays by a theatre company.

The present model of a business in which the method and system could be used contemplates that a transaction fee would be collected by the operator of the system on the purchase price of a ticket sold through the system and split between the operator of the system and the Venue. The buyer and the seller would each pay a portion of the transaction fee. The buyer's credit card would be charged with the agreed purchase price, which would be limited to a maximum of the face value of the ticket, plus a first portion of the transaction fee. The seller's credit card would in turn be credited with the agreed purchase price, less a second portion of the transaction fee. A courier fee would also be charged to the seller's credit card to cover the cost of picking up the ticket and delivering it to the Venue's will-call booth, unless the seller agrees to deliver the ticket to the Venue's will-call booth. The business model further contemplates that the Venue would provide the operator of the system with access to its database of season ticket holders and handle acceptance from sellers and delivery of tickets to buyers at the Venue's will-call booth. The business model, including the paying of a portion of the transaction fee to the Venue and the involvement of the Venue in the operation of the system, is believed to be unique.

A prospective buyer may enter a bid into the system for a ticket in a section of seats having the same face value even if no seats in that section are currently posted for sale. The prospective buyer may withdraw the bid at any time before a season ticket holder accepts the bid, but if the bid is accepted before being withdrawn, the buyer must accept the ticket if it is in the section for which the bid was entered. In other words, a prospective purchaser can bid on a specific ticket that is posted for sale at a price higher than the prospective purchaser's bid or on any ticket in a specific section of seats, all of which have the same face value, whether or not there are any tickets in that section posted for sale. Conversely, if a ticket is posted (offered) for sale and a prospective purchaser accepts the offer using the system before the posting is withdrawn, then the season ticket holder must tender the ticket and complete the transaction.

The implementation described could also be integrated or coordinated with offering for sale of unsold non-season tickets so that a prospective ticket purchaser could purchase a ticket selected from all tickets available for an event, including both non-season tickets and tickets put up for sale by season ticket holders. In that case, the prospective purchaser could bid on unsold non-season tickets as well as tickets put up for sale by season ticket holders.

While the method and system is described above in terms of a business model providing for remarketing of season tickets, the method and system can be applied to remarketing any tickets that have been purchased before an event, including single non-season tickets.

### BRIEF DESCRIPTION OF DRAWINGS

FIG. 1 illustrates an embodiment showing how a buyer may accept an offer to sell or post an offer to buy.

FIG. 2 illustrates an embodiment showing how a seller may accept an offer to buy or post an offer to sell.

FIG. 3 illustrates an embodiment showing how collection of tickets is arranged by the ticket remarketing facility.

FIG. 4 illustrates an embodiment showing how a validation of tickets is carried out by the Venue.

FIGS. 5 31 are screen shots taken at various points in the flowcharts of FIGS. 1-4.

### DETAILED DESCRIPTION

The invention is embodied in a computer-based ticket remarketing facility for buying and selling season tickets that would otherwise not be used by season ticket holders. In the preferred embodiment, the ticket remarketing facility is a website, the URL of which is www.repeatseat.com. The following description uses as an example a fictitious soccer team called the “Calgary Demonstrators” that plays in a fictitious league called the “Major League Soccer”. Users of the ticket remarketing facility are prospective buyers and sellers of tickets to home games of the Calgary Demonstrators, the operator of the remarketing facility, and the Calgary Demonstrators team or whatever entity administers ticket-selling facilities for it. Fundamentally, the method and system provides a comprehensive facility for efficiently buying and selling season tickets that would otherwise be unused.

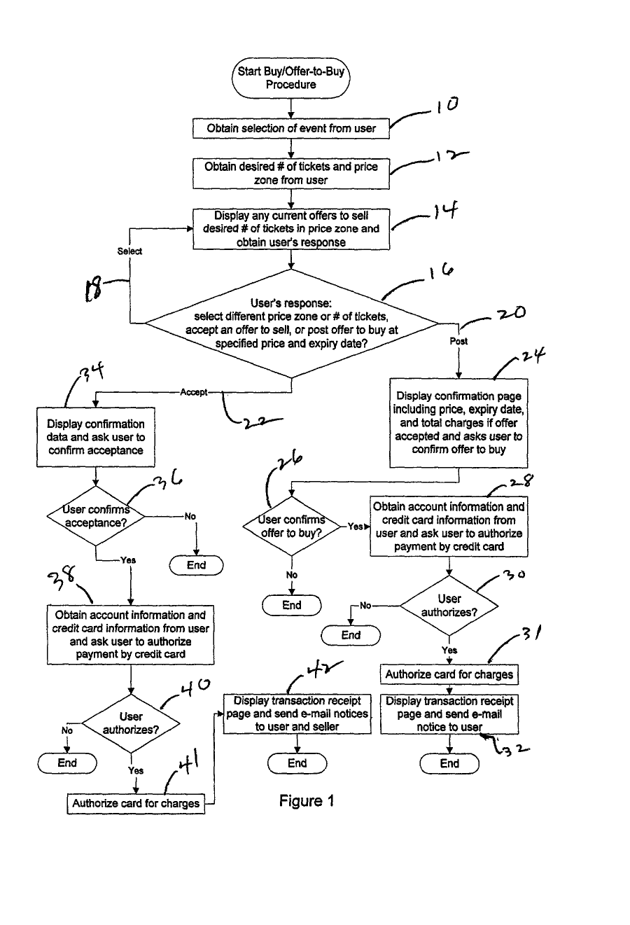

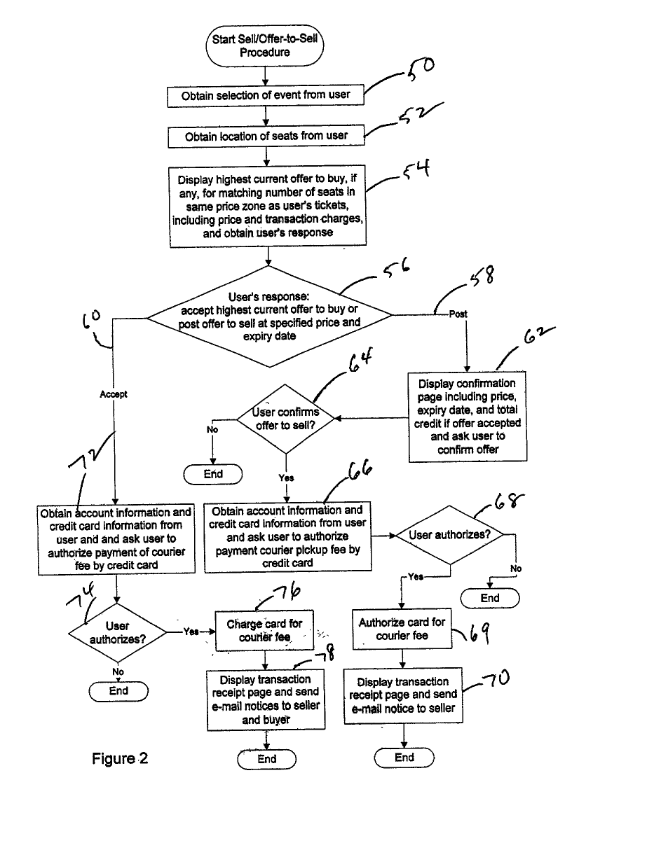

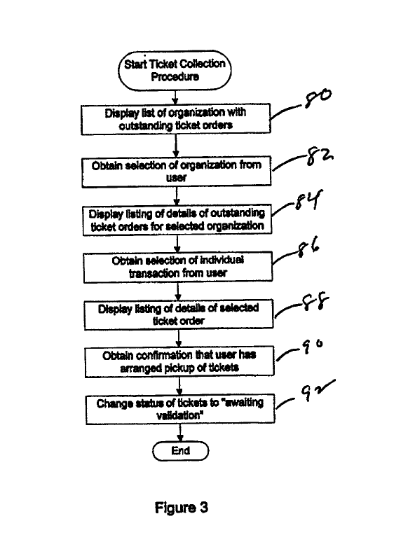

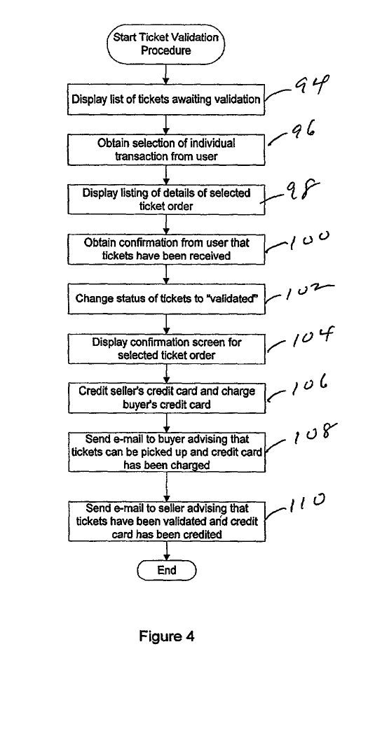

The presently preferred embodiment of the invention is described below by a set of flowcharts in FIGS. 1 4 and a corresponding set of screen shots that would be displayed to users of the website. FIG. 1 describes what occurs when a user visits a website (www.repeatseat.com) to buy tickets to a specific home game of the Calgary Demonstrators. FIG. 2 describes what occurs when a user visits that website to sell tickets to a specific home game of the Calgary Demonstrators. FIG. 3 describes what occurs when a user working for the operator of the remarketing facility uses the system hosting the website to arrange pickup of tickets sold using the website. FIG. 4 describes what occurs when a user-administrator for the operator of the ticket-selling facility visits the website to deal with tickets that have been picked up from sellers.

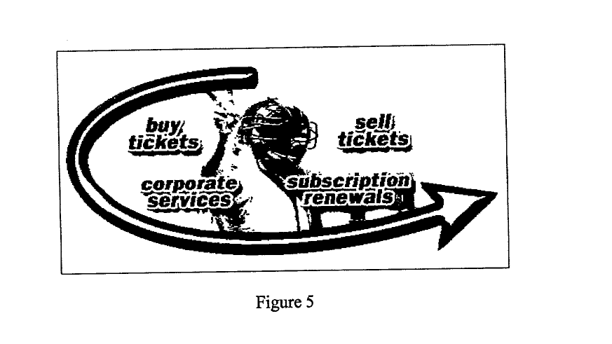

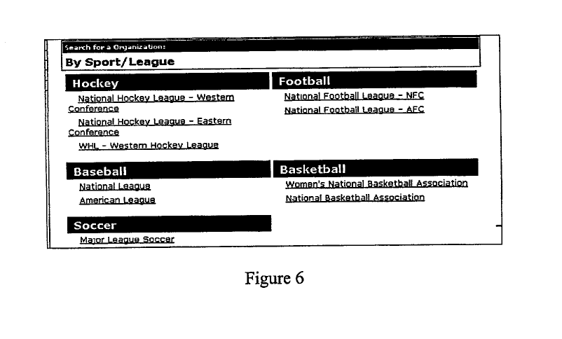

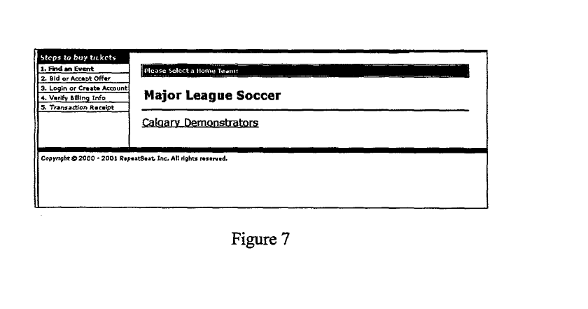

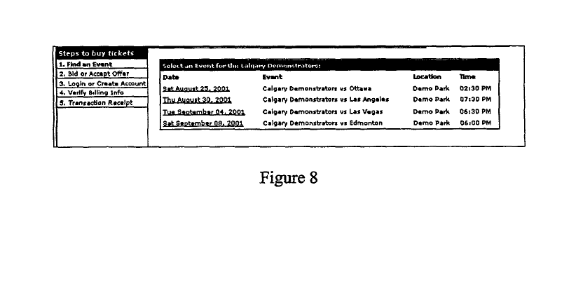

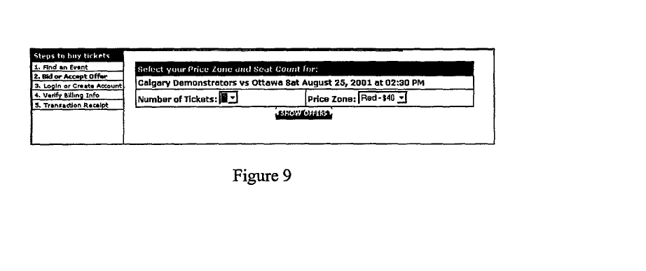

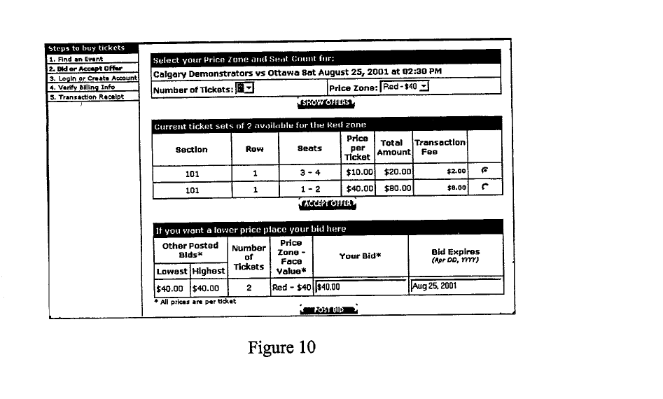

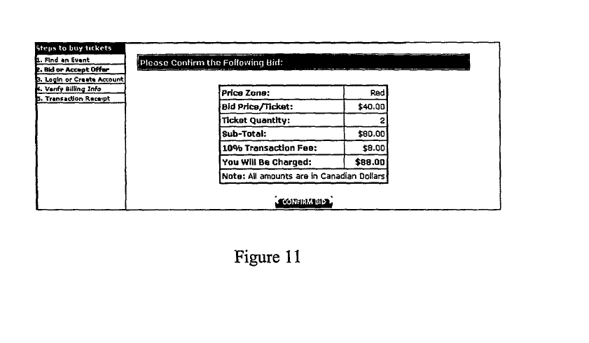

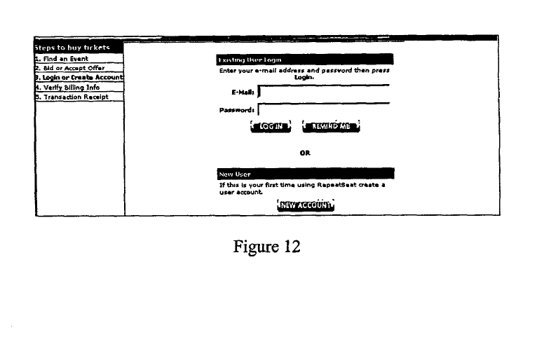

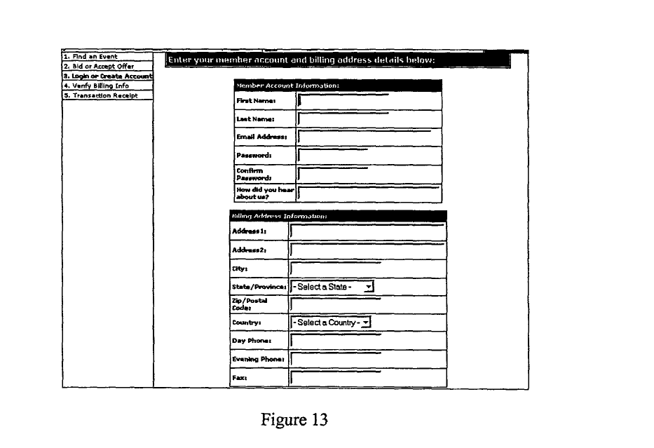

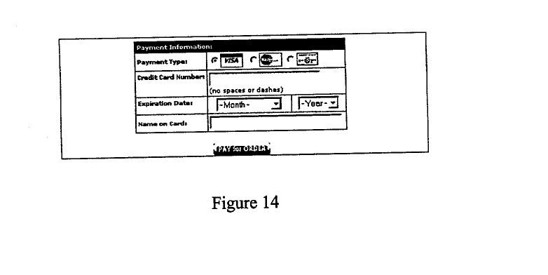

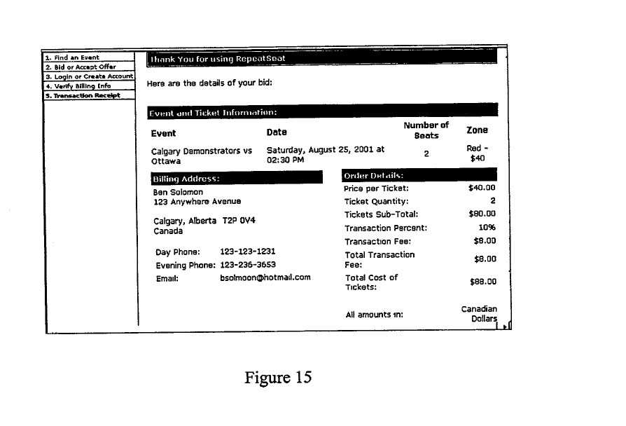

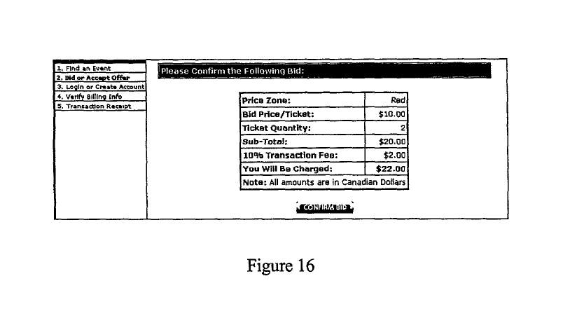

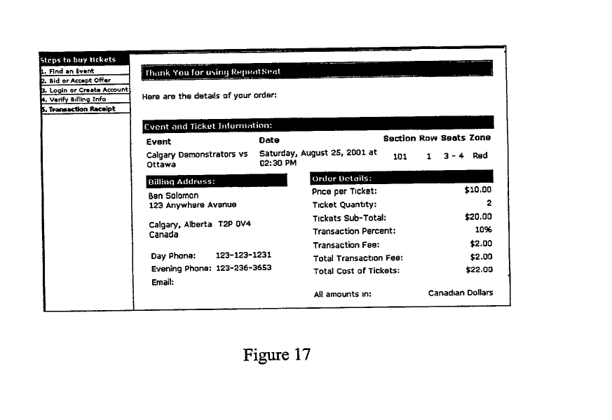

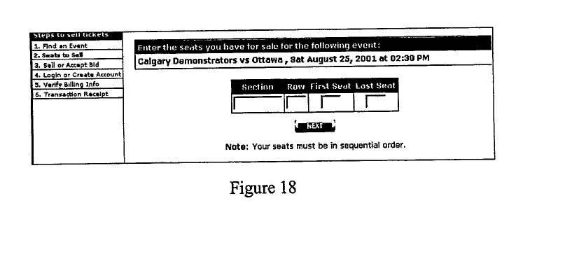

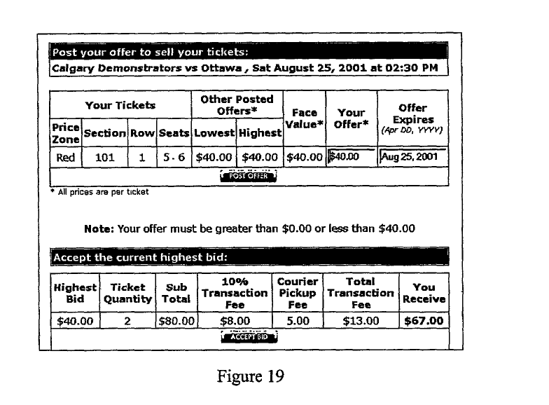

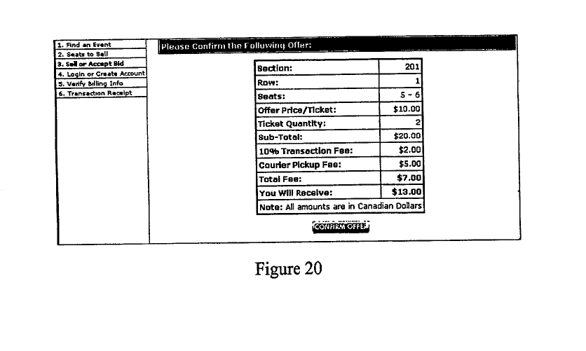

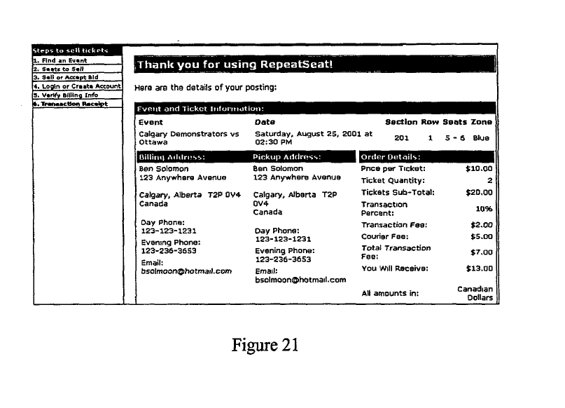

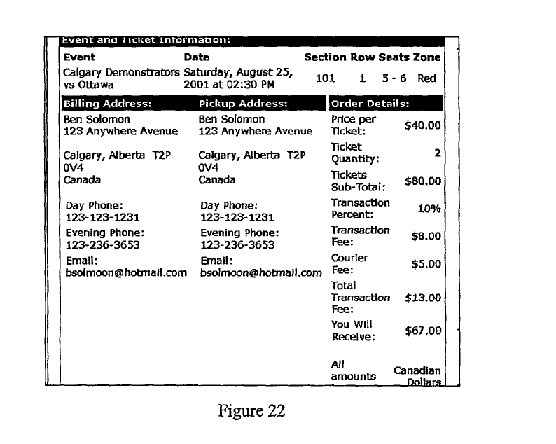

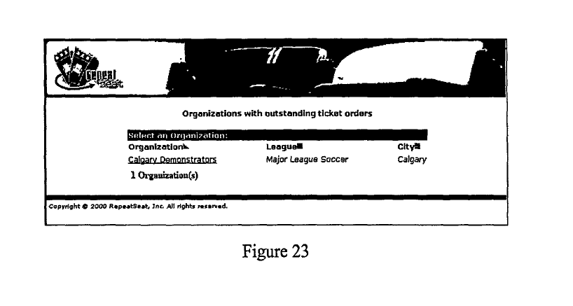

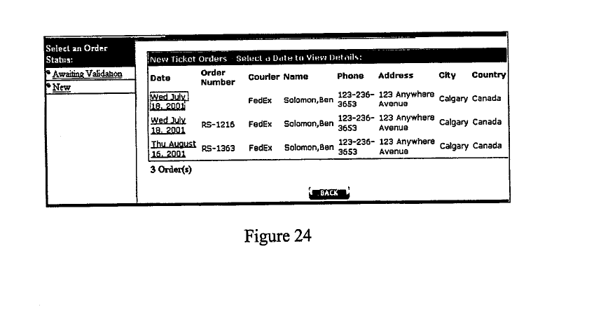

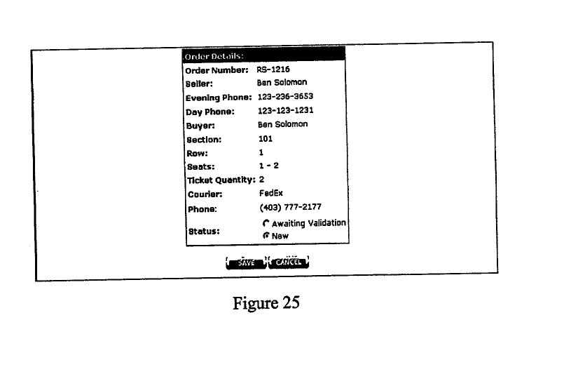

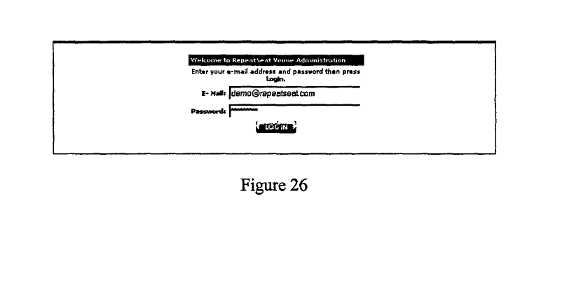

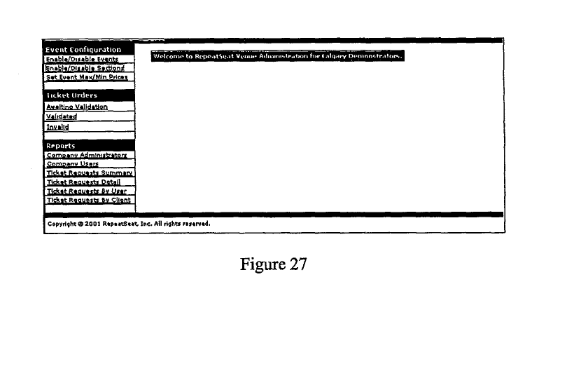

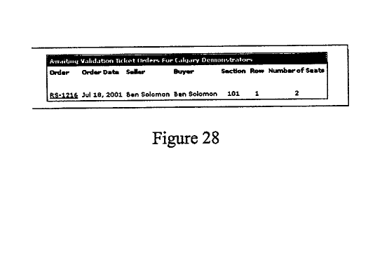

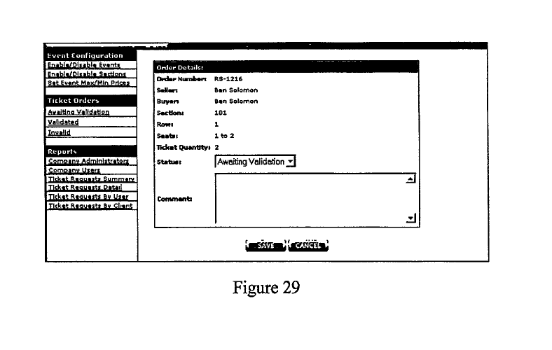

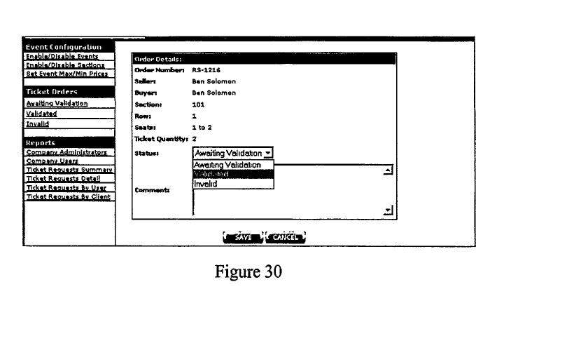

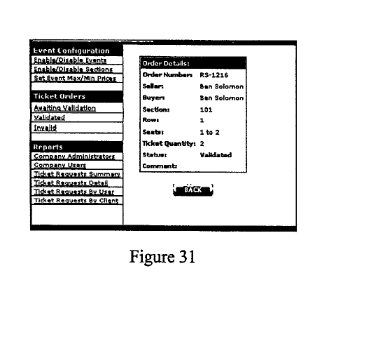

The processes illustrated in FIGS. 1, 2, and 4 begin when a user logs on to the www.repeatseat.com website and clicks the “Sporting Events” hyperlink displayed on the main page at that website. FIG. 5 (the “Sports Main Menu”) is then displayed to the user. The Sports Main Page provides hyperlinks labeled “buy tickets”, “sell tickets”, “corporate services”, and “subscription renewals”. FIG. 1 describes the processing that occurs if the “buy tickets” hyperlink is clicked, FIG. 2 describes the processing that occurs if the “sell tickets” hyperlink is clicked, and FIG. 4 describes the processing that occurs if the “corporate services” hyperlink is clicked. The “subscription renewals” hyperlink is not active in the current embodiment and is outside the scope of the claimed invention. The processing that is described in FIG. 3 is carried out by via an internal connection to the system hosting the website so that no hyperlink is provided on the Sports Main Menu page.

Buy TicketsAssuming that the user is looking for tickets to a Calgary Demonstrators' game, the user will click the “buy tickets” hyperlink in FIG. 5. The series of steps shown in FIG. 1 will then commence. First, in block 10 of FIG. 1 the user is asked to select a particular event, in this case a game on a particular date. FIGS. 6, 7, and 8 are used to obtain the selection. The user is presented in FIG. 6 with a list of teams organized by sport so that the user may select the team from which to buy home game tickets. In order to do this, the user must first select the league in which the team plays. In the example shown in FIG. 6, a fictitious league called the “Major League Soccer” is listed under “Soccer”. If the user selects that league by clicking the Major League Soccer hyperlink, then a list of teams in that league is presented in FIG. 7. In this example, only a fictitious team called the “Calgary Demonstrators” is listed in FIG. 7. If the user clicks on the “Calgary Demonstrators” hyperlink, a list of home games to be played by that team is displayed as shown in FIG. 8. The user may then select the home game for which the user wishes to buy tickets by clicking on a hyperlink for date of the home game. In this example, the user has clicked on the Aug. 25, 2001 hyperlink and been presented with FIG. 9.

Next, in block 12, the user's selection of a desired number of tickets and price zone are requested. To do so, in FIG. 9 a form is presented in which there are two selections for the user to make before the user clicks a button to show any offers to sell that have been previously posted by other users. The first selection provides the number of ticket sought by the user and the second provides the price zone for the tickets sought.

If the user clicks the “Show Offers” button in the form shown in FIG. 9, then in block 14 a list of current offers to sell and a form for inputting an offer to buy are added to the form for selecting the number of ticket and price zone that was displayed in FIG. 9. The combined display is shown in FIG. 10. At this point the user has to decide (block 1 6 of FIG. 1) which of three courses of action is desired. The first course of action (arrow 18 of FIG. 1) is to change the number tickets or the price zone or both and click the “Show Offer” button again to obtain a new list of offers. The second course of action (arrow 20 of FIG. 1) is to post an offer to buy, presumably because none of the tickets offered for sale are acceptable because the offering price is too high. In this case, the user may enter an offer-to-buy price and an expiry date for the offer to buy in the form and click “Post Bid”. The third course of action (arrow 22 of FIG. 1) is to accept one of the posted offers to sell by clicking a corresponding radio button and then the “Accept Offer” button.

The first course of action 18 is straightforward. Control loops back to block 14 and any posted offers for a new number of tickets and price zone are displayed.

The second course of action 20 causes control to proceed to block 24 at which a confirmation page showing the price zone, price per ticket, total quantity of tickets, subtotal of ticket price, a transaction fee, and the total charge to be displayed. An example confirmation page is shown in FIG. 11. The displayed confirmation page also includes a button labeled “Confirm Bid” to confirm and post the offer to buy. In the example, a 10% transaction fee is added to the offer to buy. The transaction fee may be evenly split between the organization (the Calgary Demonstrators) and the operator of the ticket remarketing facility. At this point the user″s credit card is not charged the total amount but only authorized to ensure that payment can be made in case the transaction is completed in the future. To continue the user at block 26 must click the “Confirm Bid” button. The User Login page, illustrated in FIG. 12, is then displayed at block 28. If the user has used the ticket remarketing facility before then the user simply enters an email address and password and clicks a button labeled “Log In” in order to proceed. If this is the first time that the user has used the ticket remarketing facility, then the user will need to create an account by clicking a button labeled “New Account” and complete the form shown in FIG. 13, which is then displayed. The form collects typical user information such as name, address, telephone numbers, etc. After the user has completed the form and clicked a button on the form labeled “Next”, or if the user already has an account and clicked the “Log In” button on FIG. 1 2, credit card information is obtained using the form displayed in FIG. 14. The credit card information is obtained to be used to immediately authorize the credit card for the total price that the user has offered to pay so that if a seller accepts the offer to buy, then the transaction can be completed with the assurance that the user will pay if the tickets are tendered by the seller. Once the user submits his credit card information and clicks at block 30 in FIG. 1 a button labeled “Pay for Order” on the form shown in FIG. 14, then the charge to the credit card is authorized at block 31 and at block 32 a transaction receipt page shown in FIG. 15 is displayed showing all of the details of the user's offer to buy and an email is immediately be sent to the user confirming that the offer to buy has been posted. The offer to buy will then remain open for acceptance until the expiry date unless the user retracts the offer to buy. Other users of the system can view the offer to buy and accept it to complete a transaction.

The third course of action 22 causes control to proceed to block 34 of FIG. 1 if the user has clicked a radio button selecting a specific offer to sell on the list of offers shown in FIG. 10 and clicked “Accept Offer”. If the user takes action 22, then at block 34 the confirmation page shown in FIG. 16 is displayed and the user is asked to confirm acceptance of the offer to sell by clicking a button labeled “Confirm Bid” on FIG. 16. If the user at block 36 clicks that button, then at block 38the User Login page form, illustrated in FIG. 12, is displayed. If the user has used the ticket remarketing facility before then the user simply enters an email address and password and clicks a button labeled “Log In” in order to proceed. If this is the first time that the user has used the ticket remarketing facility, then the user will need to create an account by clicking a button labeled “New Account” and complete the form shown in FIG. 13, which is then displayed. The form collects typical user information such as name, address, telephone numbers, etc. After the user has completed the form and clicked a button on the form labeled “Next”, or if the user already has an account and clicked the “Log In” button on FIG. 12, credit card information is obtained using the form displayed in FIG. 14. The credit card information is used to immediately authorize the credit card for the total price that the user has agreed to by accepting the offer to pay to the seller so that the transaction can be completed with the assurance that the user will pay if the tickets are tendered by the seller. Once the user submits his credit card information and clicks a button labeled “Pay for Order” on the form shown in FIG. 14, the transaction receipt page shown in FIG. 17 is displayed showing all of the details of the transaction. Emails are immediately sent out to both the seller and the buyer notifying them of the completed transaction.

Sell TicketsAssuming that the user wishes to sell tickets to a Calgary Demonstrators game, the user will click the “sell tickets” hyperlink in FIG. 5. The series of steps shown in FIG. 2 will then commence. First, the user must in block 50 input data specifying the event, in this case a particular Calgary Demonstrators game, and in block 52, input data specifying the location of the tickets that the user wishes to sell. The screen displayed to the user and process summarized in block 50 are identical to that described above in relation to FIGS. 6, 7, and 8. At block 52 in order to obtain the location of the tickets, FIG. 18 is presented for the user to allow the user to enter the section, row, and first and last seats of the tickets that the user wishes to sell. That form also provides a “Next” button. At block 54, after the user has filled in the location data and clicked the “Next” button on the form shown in FIG. 18, the form shown in FIG. 19 is displayed providing the highest current offer to buy the number of tickets that the user wishes to sell in the price zone of the tickets the user wishes to sell and a form for inputting an offer to sell. At this point the user has to decide at block 56 which of two courses of action is desired. The first course of action indicated by arrow 58 to post an offer to sell, presumably because the highest offer to buy was too low. In this case, the user may enter an offer-to-sell price and an expiry date for the offer to sell in the form and click “Post Offer”. If the venue is located in an area in which ticket “scalping” is not allowed, the offer cannot exceed the face value of the tickets. The second course of action indicated by arrow 60 is to accept the posted offer to buy displayed FIG. 19 by clicking a corresponding radio button and then the “Accept Bid” button.

The first course of action 58 causes control to proceed to block 62 at which a confirmation page showing the ticket locations, price per ticket, total quantity of tickets, subtotal of ticket price, a transaction fee, a courier pickup fee, and the total charge to be displayed. An example confirmation page is shown in FIG. 20. The displayed confirmation page also includes a button labeled “Confirm Offer” to confirm and post the offer to sell. In the example, a 10% transaction fee is added to the offer to sell as well as a $5 courier pickup fee. The transaction fee may be evenly split between the organization (the Calgary Demonstrators) and the operator of ticket remarketing facility. At block 64, to continue the user must click the “Confirm Offer” button in FIG. 20. Then, at block 66, the process described above and illustrated in FIGS. 12 14 for opening a new account, if necessary, and obtaining credit card information is carried out. In addition, the user must then complete a “Pickup Address Information” form (not shown). The information from that form will be used to notify a courier of the address to pick up any tickets that are sold. By default this form will contain the same address information as the billing information in the “New Member” form although the information can be changed if the pickup address is a different from the billing information. In this case, however, the credit card information is collected so as to be able to credit the user if the tickets offered for sale are sold and to be able to charge the courier fee. Once the user submits the credit card information and clicks a button labeled “Pay for Order” on the form shown in FIG. 14 (block 68 in FIG. 2), then a charge to the credit card for the courier fee is authorized in block 69 and a transaction receipt page shown in FIG. 21 is displayed at block 70 showing all of the details of the user's offer to sell. An email will also immediately be sent to the user confirming that the offer to sell has been posted. The offer to sell will then remain open for acceptance until the expiry date unless the user retracts the offer to sell. Other users of the system can view the offer to sell and accept it to complete a transaction.

The second course of action 60 in FIG. 2 causes control to proceed to block 72 if the user has clicked the “Accept Bid” button in FIG. 19. At block 72, the process described above and illustrated in FIGS. 12 14 for opening a new account, if necessary, and obtaining credit card information is carried out. In addition, the user must then complete a “Pickup Address Information” form (not shown). The information from that form will be used to notify a courier of the address to pick up the tickets. By default this form will contain the same address information as the billing information in the “New Member” form although the information can be changed if the pickup address is a different from the billing information. In this case, however, the credit card information is collected so as to be able to credit the user if the sale is completed and to be able to charge the courier fee. Once the user submits the credit card information and clicks a button labeled “Pay for Order” on the form shown in FIG. 14 (block 74 in FIG. 2), then a charge to the credit card for the courier fee is made in block 76 and a transaction receipt page shown in FIG. 22 is displayed at block 78 showing all of the details of the sale. An email will also immediately be sent to the user and buyer confirming that the transaction.

Collect Tickets When a ticket sale has been completed there is a process in place to collect the tickets from the seller and deliver them to the venue. Once the tickets have arrived at the venue the box office must validate the tickets and then charge the buyer″s credit card and credit the seller″s credit card. This process is handled partly by operator of the ticket remarketing facility and partly by the venue.

When a transaction is completed the responsibility of picking up the tickets from the seller is that of the ticket remarketing facility. This process is shown in FIG. 3. This is done with an administration web page that is called RSDispatch. When a user (a member of the staff of the operator of the ticket remarketing facility) accesses RSDispatch, the first thing that is displayed 80 is a list of organizations for which there are outstanding ticket orders. An exemplary display is shown in FIG. 23. A ticket order is considered to be outstanding if there has not yet been a courier dispatched to collect tickets from a completed transaction. For the purposes of this document a fictional professional soccer team, The Calgary Demonstrators, will again be used. A user must, at block 82, click the “Calgary Demonstrators” button in FIG. 23 to view the outstanding ticket orders for the Calgary Demonstrators. The user is then presented 84 with a list of outstanding ticket orders as illustrated in FIG. 24. When the user clicks 86 on the date of an individual transaction, the details of the transaction are displayed 88 as well as the seller″s pickup address as illustrated in FIG. 25. The user must then call the designated courier company to arrange pick up of the tickets. Once this is done 90, the user must change 92 the status of the order from “New” to “Awaiting Validation”. The user must then click the “Save” button to complete the dispatch process.

Validate Tickets Once a courier has been dispatched to pick up the tickets, it is now the task of the venue to validate the tickets. This is done using a venue administration web page that is called RSVenue. In order to access RSVenue a user (a member of the venue″s staff) must click the “corporate services” hyperlink on FIG. 5. FIG. 26 is then displayed so that the user may login using their venue″s designated email address and password. Once logged in, FIG. 27 is displayed and the user must select “Awaiting Validation” from the menu on the left side of the page. A list of all tickets that are awaiting validation will then be displayed 94 as in for example FIG. 28. In other words, tickets that couriers have been dispatched to pick up, but have not yet arrived at the venue. When the venue receives the tickets, a user must validate the tickets by clicking 96 the appropriate RepeatSeat Order Number in FIG. 28. The ticket details will then be displayed 98 as in FIG. 29. In order to change the status of the ticket order the user must make the appropriate selection 102 from the “Status” drop-down menu. Once the appropriate selection has been made as in FIG. 30, the user must click the “Save” button to continue. When the status of a ticket order has been changed a confirmation screen will be displayed 104, showing the new status of the order. For an example, see FIG. 31.

Once a ticket is validated, the seller credit card is credited 106 for the appropriate amount and the buyer″s credit card is charged 106. An email is automatically sent out to the buyer and the seller. One email is sent 110 notifying the seller that the tickets have been validated and stating the amount that has been credited to his credit card. The other email is sent 108 notifying the buyer that his tickets can be picked up at the venue and stating the amount that will be charged to his credit card.

Appendix A SPORTS BUY Programming LogicApplication StartupRead defaults from file system to obtain database connection information.

Connect to database using defaults.

Read common data into shared editing context.

Dump application startup/configuration information to console.

Sports/League List PageFetch list of sports from database.

For each sport, fetch list of sporting leagues.

Display league names as hyperlinks.

Organization PageWhen the user clicks on an organization, set the selected organization on the Session.

Execute viewEvents method.

Fetch list of all future events for selected organization.

Events List PageFor selected organization, display list of all future events sorted in ascending order by event date.

Event date surrounded by hyperlink.

When the user clicks on the event date hyperlink, call the selectEvent method which creates a new BuyTicketAction if it hasn't already been created. Store it on the current Session object. Insert it into the default editing context.

Associate the newly created BuyTicketAction with the selected event and also the currency for the current venue configuration.

Send the selected event to the Event Bid Page.

Event Bid PageDisplay popups to allow the user to choose the number of tickets to purchase and in which price zone.

Once the user selects the number of tickets to purchase and the price zone, clicking on the Show Offers button executes the showoffers method.

The showOffers method fetches from the database a list of all SellTicketActions that match the selected event, number of tickets, and price zone. Restrict the number of SellTicketActions to 4, sorted by sell price and posted date. Filter out those tickets that are for sections that have been disabled by the Venue.

Display list of SellTicketActions in a table with a radio button next to each.Buyer Accepts OfferSelecting the SellTicketAction by clicking on a radio button and pressing the Accept Offer button causes the status of the SellTicketAction to be set to BUYER ACCEPTS OFFER. The SellTicketAction is saved on the Session object.

If the user changes his mind and chooses a different offer, the originally chosen offer (now on the Session) must have its status changed back to POSTED.

Once an offer is accepted, a new BuyTicketAction on the Session has its attributes set to the attributes of the selected SellTicketAction. The amount, expiry date, seat count, price zone, section, seat number start, seat number end, and row number are copied from the SellTicketAction to the BuyTicketAction. The BuyTicketAction″s status is also set to BUYER ACCEPTS OFFER.

When the offer is accepted, an actual TicketOrder object is now created, inserted into the editing context, and stored on the Session object.

The TicketOrder object has its courier object set to the courier used by the organization. Its pickup address is set to the member″s pickup address. The organization is set on the TicketOrder. The status of the order is set to ORD NEW.

The selected SellTicketAction is also associated with the new TicketOrder. The joining of a BuyTicketAction and a SellTicketAction is basically what constitues a TicketOrder.

Return the BuyConfirmBidPage.Buyer Posts BidIf the buyer doesn″t like the prices offered by the sellers or there aren″t any sell offers, the buyer can enter their own bid for a set of tickets. Display the form that enables the buyer to set a price.

When the user clicks on Post Bid, execute the postBid method.

The postBid method first grabs the BuyTicketAction from the Session (causing it to be created if it doesn″t already exist) then sets the bid amount and the bid expiry date on the BuyTicketAction to the amount and bid expiry date the user entered into the form. Also sets the price zone, event, and sets the status to NEW.

Generate the list of TicketActionitems for this bid. TicketActionitems are the amounts and totals of the transaction fees for a bid or offer.

Perform the following validations on the bid:Bid amount cannot be empty.

Bid amount must be a positive value.

Bid amount must be less than or equal to the maximum amount defined by the venue for that event.

Bid amount must be greater than or equal to the minimum amount defined by the venue for that event.

Bid expiry date must not be empty.

Bid expiry date must not be later than the event″s offer expiry date.

Bid expiry date must be later than the current date.

Return the BuyConfirmBidPage.

Buy Confirm Bid PageDisplay the details of the current BuyTicketAction that is on the Session object.

Clicking on the ConfirmBid button returns the BuyMemberLoginPage.

Buy Member Login PageDisplay the Login component requesting the user″s e-mail address and password.

Perform the following validations when the login button is clicked:E-mail address is not empty.

Password is not empty.

Member is found in the database which matches the given e-mail address and password.

Clicking on the Remind Me button verifies that you have at least entered an e-mail address, then it searches the database for a member with that e-mail address. If one is found, it e-mails a reminder notice to the e-mail address specified.

Once a member is found for the given e-mail address and password, return the BuyMemberDetailsPage.

If the user clicks on the New Account button, make sure they didn″t already click on the New Account button at a previous time. If they did, clear that old Member object out of the Session and remove it from the default editing context.

Create a new Member object, insert it into the default editing context, and set the Session″s currentMember to the newly created Member.

Return the BuyMemberDetailsPage.

Buy Member Details PageCreate a new MemberAddress object for the user″s billing address. Relate it to the current member.

The user fills out the Member Information and Billing Address Information.

Perform the following validation on the member information and billing address information:If this is a new user or they change their e-mail address, make sure the email address isn″t already being used by someone else.

Make sure the required fields aren″t empty:E-mailFirst nameLast nameAddress 1PasswordConfirm PasswordCityState/ProvincePostal/Zip CodeCountryWork Phonelf the member information and billing address information pass validation, return the BuyPaymnentInfoPage, otherwise, return the same page and display an error message and mark all the fields in error with red “!!!”.

Buy Payment Info PageStore the BuyPaymentInfoPage on the Session object because we″ll need it later if we fail credit card authorization and need to return to it.

If it hasn″t already been created, create a PaymentInfo object and relate it to the current BuyTicketAction on the Session. Insert the PaymentInfo object into the default editing context.

The user enters their credit card information into the form and presses the Pay for Order button.

When the Pay for Order button is pressed, execute the pay method.

The pay method grabs the BuyTicketAction and current Member objects from the Session object.

Relate the new PaymentInfoObject to the current Member object.

Create a new AuthorizationTransaction object and insert it into the default editing context.

Set the new AuthorizationTransaction object″s status to NEW.

Relate the new AuthorizationTransaction object to the BuyTicketAction. This adds the AuthorizationTransaction object to an array of Transaction objects on the BuyTicketAction.

Calculate the “Buyer Pays Amount”fee as follows:(Ticket Price * Ticket Quantity)+Total Transaction FeeSet it to the AuthorizationTransaction object″s amount attribute.

Save the changes in the default editing context to the database. This is done at this point in order to generate a primary key for the AuthorizationTransaction object. We use the primary key of the AuthorizationTransaction object to generate a transaction number.

If the user had accepted an offer, the TicketOrder will have been created by this point. Generate an order number for the TicketOrder.

Authorize Payment with ExactCreate a new Exact object.

Execute the authorizeCard method on the Exact object.

If the credit card is authorized and the user is just posting a bid, set the status of the BuyTicketAction to POSTED.

If the credit card is authorized and the user is accepting an offer, set the status of the BuyTicketAction to BUYER CONFIRMS ORDER. Set the status of the SellTicketAction to BUYER CONFIRMS ORDER.

Save the changes to the database.

If the buyer is accepting an offer, generate the offer accepted email and send it to the seller. Also generate an offer accepted e-mail and send it to the buyer so they have a record of the transaction.

If the buyer is simply posting a bid, generate the bid posted e-mail and send it to the buyer as a record of the transaction.

If the buyer is accepting an offer and the authorization succeeded, return the BuyOfferCustomerInvoicePage.

If the buyer is simply posting a bid and the authorization succeeded, return the BuyBidCustomerInvoicePage.

If the authorization fails, return the AuthorizationFailedPage and set the transaction status to ORD CREDIT CARD AUTHORIZATION FAILED.

Set the transaction message to the message returned by the E-xact gateway. This will usually be something like “BAD CARD NUMBER”, etc.

Save the changes to the database so we have a record of any failed transactions.

Buy Offer Customer Invoice PageDisplay the details of the buyer″s offer acceptance.

Terminate the user″s session.

Buy Bid Customer Invoice PageDisplay the details of the buyer″s bid.

Terminate the user″s session.

Authorization Failed PageDisplay the error message from the E-xact gateway along with a Try Again button.

Appendix B SPORTS SELL Programming LogicApplication StartupRead defaults from file system to obtain database connection information.

Connect to database using defaults.

Read common data into shared editing context.

Dump application startup/configuration information to console.

Sports/League List PageFetch list of sports from database.

For each sport, fetch list of sporting leagues.

Display league names as hyperlinks.

Organization PageWhen the user clicks on an organization, set the selected organization on the Session.

Execute viewEvents method.

Fetch list of all future events for selected organization.

Events List PageFor selected organization, display list of all future events sorted in ascending order by event date.

Event date surrounded by hyperlink.

When the user clicks on the event date hyperlink, call the selectEvent method which creates a new SellTicketAction if it hasn″t already been created. Store it on the current Session object. Insert it into the default editing context.

Associate the newly created SellTicketAction with the selected event and also the currency for the current venue configuration.

Send the selected event to the Sell Event Offer Page.

Sell Event Seats PageDisplay a form for the user to enter their Section, Row, First Seat and Last Seat.

When the user clicks the Next button, execute the Proceed method.

The Proceed method performs the following validation:Section, Row, First Seat and Last Seat must not be emptyFirst Seat and Last Seat must be positive numeric values>0.

First Seat must be less than Last Seat.

Section exists in the database for the venue where the event is being held.

Section must be enabled by the RepeatSeat administrator.

The seats must exist for the specified section and row.

The tickets haven″t already been posted by someone else.

Retrieve the Price Zone from the Section for the specified row.

Relate the following attributes to the SellTicketAction that is on the Session object:Price ZoneEventSectionThe Venue″s CurrencySet the seat count on the SellTicketAction by using the following formula:ABS(Last Seat First Seat)+1.

Return the SellEventOfferPage.

Sell Event Offer PageDisplay the information about the previously entered tickets.

The information about the tickets includes a form the user can fill out to enter the offer expiry date (which is defaulted to the event″s offer expiry date) and the offer amount (which is defaulted to the maximum amount for the specified price zone).

Display the maximum and minimum offer amount for other offers in the system.

Display a Post Offer button.

If one or more bids exist for the price zone of the seller″s tickets, display the one with the highest bid amount. Display an Accept Bid button.

Seller Posts OfferIf the seller posts an offer, execute the postOffer method.

The postOffer method performs the following validation:If an existing TicketOrder exists, get rid of it because the user may have previously accepted an offer (creating a TicketOrder) and then changed his mind to go back and post an offer.

Ticket price must not be empty.

Ticket price must be a positive, non-zero value.

Ticket price must be less than event price zone range maximum.

Ticket price must be greater than event price zone range minimum.

Offer expiry date must be earlier than the event″s offer expiry date and later than the current date.

Generate ticket action items to record the transaction details for this offer posting.

Set the amount and the expiry date on the SellTicketAction that″s on the Session object.

Return the SellConfirmOfferPage.

Seller Accepts Highest BidIf the seller accepts the highest bid, execute the acceptBid method. Here we″re actually creating the order that joins the BuyTicketAction (the buyer″s bid) and the SellTicketAction (the seller″s offer).

The acceptBid method first checks to see if the user didn″t already accept a bid and then backtrack. If they did, reset the status of the bid″s BuyTicketAction back to POSTED and save the BuyTicketAction back to the database for someone else to accept.

Set the current SellTicketAction″s amount to the amount of the highest bid″s BuyTicketAction.

Set the section, row, and seat count on the highest bid BuyTicketAction to the section, row and seat count of the seller″s tickets.

Create a new TicketOrder, insert it into the default editing context and store it on the Session object.

Relate the event″s organization to the TicketOrder.

Relate the SellTicketAction and the highest bid BuyTicketAction to the TicketOrder.

Set the status of the SellTicketAction and the highest bid BuyTicketAction to SELLER ACCEPTS BID.

Save the BuyTicketAction back to the database right away so nobody else can accept the same highest bid.

Set the courier on the TicketOrder to the courier used by the organization.

Generate ticket action items to record the transaction details for this order.

Return the SellMemberLoginPage.

Sell Confirm Offer PageDisplay the details of the current SellTicketAction that is on the Session object.

Clicking on the Confirm Offer button returns the SellMemberLoginPage.

Sell Member Login PageDisplay the Login component requesting the user″s e-mail address and password.

Perform the following validations when the login button is clicked:E-mail address is not empty.

Password is not empty.

Member is found in the database which matches the given e-mail address and password.

Clicking on the Remind Me button verifies that you have at least entered an e-mail address, then it searches the database for a member with that e-mail address. If one is found, it e-mails a reminder notice to the e-mail address specified.

Once a member is found for the given e-mail address and password, return the BuyMemberDetailsPage.

If the user clicks on the New Account button, make sure they didn″t already click on the New Account button at a previous time. If they did, clear that old Member object out of the Session and remove it from the default editing context.

Create a new Member object, insert it into the default editing context, and set the Session″s currentMember to the newly created Member.

Return the BuyMemberDetailsPage.

Sell Member Details PageCreate a new MemberAddress object for the user″s billing address. Relate it to the current member.

The user fills out the Member Information and Billing Address Information.

Perform the following validation on the member information and billing address information:lf this is a new user or they change their e-mail address, make sure the email address isn″t already being used by someone else.

Make sure the required fields aren″t empty:E-mailFirst nameLast nameAddress 1PasswordConfirm PasswordCityState/ProvincePostal/Zip CodeCountryDay PhoneCreate a pickup address object and relate it to the member.

Set the pickup address information to default to the billing address information.

If the member information and billing address information pass validation, return the SellMemberPickupAddressPage, otherwise, return the same page and display an error message and mark all the fields in error with red “!!!”.

Sell Member Pickup Address PageThe seller″s pickup address information is used to determine where the tickets should be picked up from.

When the user clicks the Next button, execute the next method.

The next method performs the following validation:Make sure the required fields aren″t empty:First nameLast nameAddress 1CityState/ProvincePostal/Zip CodeCountryDay PhoneReturn the SellPaymentInfoPage.

Sell Payment Info PageStore the SellPaymentInfoPage on the Session object because we″ll need it later if we fail credit card authorization and need to return to it.

If it hasn″t already been created, create a Paymentlnfo object and relate it to the current SellTicketAction on the Session. Insert the PaymentInfo object into the default editing context.

The user enters their credit card information into the form and presses the Pay for Order button.

When the Pay for Order button is pressed, execute the pay method.

The pay method grabs the SellTicketAction and current Member objects from the Session object.

Relate the new PaymentInfoObject to the current Member object.

Create a new AuthorizationTransaction object and insert it into the default editing context.

Set the new AuthorizationTransaction object″s status to NEW.

Relate the new AuthorizationTransaction object to the SellTicketAction. This adds the AuthorizationTransaction object to an array of Transaction objects on the SellTicketAction.

Set the courier fee to the AuthorizationTransaction object″s amount attribute.

Save the changes in the default editing context to the database. This is done at this point in order to generate a primary key for the AuthorizationTransaction object.

We use the primary key of the AuthorizationTransaction object to generate a transaction number.

If the user had accepted the highest bid, the TicketOrder will have been created by this point. Generate an order number for the TicketOrder.

Authorize Payment with ExactCreate a new Exact object.

Execute the authorizecard method on the Exact object.

If the credit card is authorized and the user is just posting an offer, set the status of the SellTicketAction to POSTED.

If the credit card is authorized and the user is accepting the highest bid, set the status of the SellTicketAction to SELLER CONFIRMS ORDER. Set the status of the BuyTicketAction to SELLER CONFIRMS ORDER.

Save the changes to the database.

If the seller is accepting a bid, generate the bid accepted email and send it to the buyer.

Also generate a bid accepted e-mail and send it to the seller so they have a record of the transaction.

If the seller is simply posting an offer to sell, generate the offer posted e-mail and send it to the seller as a record of the transaction.

If the authorization succeeded, return the CustomerInvoicePage.

If the authorization fails, return the AuthorizationFailedPage and set the transaction status to ORD CREDIT CARD AUTHORIZATION FAILED.

Set the transaction message to the message returned by the Exact gateway. This will usually be something like “BAD CARD NUMBER”, etc.

Save the changes to the database so we have a record of any failed transactions.

Customer Invoice PageDisplay the details of the seller″s bid acceptance or offer posting.

Terminate the user″s session.

Authorization Failed PageDisplay the error message from the Exact gateway along with a Try Again button.

Appendix C Charger Credit Card Authorization Programming LogicApplication StartupRead defaults from file system to obtain database connection information.

Connect to database using defaults.

Create instance of DaemonCharger class.

DaemonCharger class performs all the logic involved in charging credit cards.

Dump application startup/configuration information to console.

Daemon Charger Processinstantiate a timer object to be fired at 3600 second intervals.

The timer fires the daemonChargeProcess method at each 3600 second interval.

Add the timer to the current application run loop.

The daemonChargeProcess performs the following operations:Read the list of validated ticket orders from database.

For each valid ticket order:Create a new SettlementTransaction object based upon the previous AuthorizationTransaction from the buyer.

Insert the SettlementTransaction into the default editing context.

Perform a settlement transaction with the E-xact credit card authorization software to complete the buyer″s authorization transaction.

Settlement Transaction Succeedsif the settlement transaction succeeds, set the order status to ORD ORDER COMPLETE.

Set the order modification date to the current date.

Send a valid order e-mail to the buyer and seller.

Relate the settlement transaction to the authorization transaction and to the list of transactions on the BuyTicketAction for the order.

Save the changes to the database. We do this now in order to generate a primary key. The primary key is used as a basis for the transaction number.

Generate a transaction number for the settlement transaction.

Settlement Transaction Failsif the settlement transaction fails, set the order status to ORD CREDIT CARD AUTHORIZATION FAILED.

Set the order modification date to the current date.

At this point, an invalid e-mail should be sent to the buyer and the seller indicating the buyer″s credit card has failed settlement. This should be a rare occurrence because by this time, the buyer″s credit card would have already passed the first authorization.

Save order status changes to the database.

Appendix D Courier Dispatch Programming LogicApplication StartupRead defaults from file system to obtain database connection information.

Connect to database using defaults.

Dump application startup/configuration information to console.

Organization List PageFetch and display list of organizations that have outstanding ticket orders.

Hyperlink around the organization name.

Clicking on the organization name hyperlink executes the showOrders method.

The showOrders method returns the OrdersListPageOrders List PageDisplay a list of new ticket orders.

Hyperlink around the order date.

Display hyperlinks in the menu component in order to switch between new orders and orders awaiting validation. Orders awaiting validation will be changed to validated once the venue changes the status using the RSVenue application.

Clicking on the order date hyperlink executes the showOrderDetailsMethod.

The showorderDetails method creates the OrderDetailsPage and sets the selected order to the one the user clicked on.

Order Details PageDisplay the details of the selected order. The following details will be displayed:Order NumberSeller NameEvening PhoneDay PhoneBuyer NameSectionRowSeatsTicket QuantityCourier NameCourier Phone NumberOrder StatusThe Order Status will have a set of radio buttons with options to change the status from NEW to AWAITING VALIDATION.

The Order Status can only be changed from NEW to AWAITING VALIDATION, not the other way around.

Clicking on the save button causes the status of the order to be changed in the database.

Appendix E Venue Ticket Validation Programming LogicApplication StartupRead defaults from file system to obtain database connection information.

Connect to database using defaults.

Dump application startup/configuration information to console.

Login PageVenue administrator logs in to RSVenue application providing e-mail address and password.

Fetch VenueUser object from database for given e-mail address and password.

The VenueUser is related to the organization, so we can now determine which ticket orders we″re interested in validating.

Orders List PageDisplay a list of ticket orders for the selected order status.

The selected order status is determined by the RSVenue menue component. There are 3 order status to choose from: awaiting validation, valid orders, and invalid orders.

Hyperlink around the order date.

Clicking on the order date hyperlink executes the orderDetails method.

The orderDetails method creates the OrderDetailsPage and sets the selected order to the one the user clicked on.

Order Details PageDisplay the details of the selected order. The following details will be displayed:Order NumberSeller NameEvening PhoneDay PhoneBuyer NameSectionRowSeatsTicket QuantityCourier NameCourier Phone NumberOrder StatusThe Order Status will have a pop-up menu with options to change the status from ORD AWAITING VALIDATION to ORD VALIDATED or ORD INVALID.

The Order Status can only be changed from ORD AWAITING VALIDATION to ORD VALIDATED or ORD INVALID, not the other way around.

Clicking on the save button executes the saveChanges method.

The savechanges method relates the TicketOrder to the validating VenueUser.

If the status is changed to ORD INVALID, send an e-mail to the seller and to the buyer telling them the tickets were invalid. The buyer is told to try another set of tickets.

If the status is changed to ORD VALIDATED, send an e-mail to the buyer and seller telling them their tickets have been validated.

Once tickets are validated, it's up to the RSCharger application to charge the buyer″s credit card and change the status of the order to ORD ORDER COMPLETE.

1. A method for using a computer to facilitate both a purchase of at least one ticket to an event by a buyer from one of a group of potential sellers and a sale of at least one ticket to an event by a seller to one of a group of potential buyers, comprising,
in the case of a purchase by a buyer from one of a group of potential sellers: obtaining a desired number of tickets and price zone from the buyer;
displaying to the buyer any offers to sell currently posted by potential sellers of the desired number of tickets in the desired price zone, the display including a selling price for the tickets and a first transaction fee corresponding to each offer to sell;
determining from the buyer whether the buyer wishes to accept one of the currently posted offers to sell or to post an offer to buy the desired number of tickets at a specified price, and
if the buyer wishes to accept one of the currently outstanding offers to sell, then preauthorizing a charge to a credit card account of the buyer for the selling price and the first transaction fee corresponding to the accepted offer to sell, or if the buyer wishes to post an offer to buy the desired number of tickets at a specified price, then preauthorizing a charge to a credit card account of the buyer for the specified buying price and the first transaction fee; and
in the case of a sale by a seller to one of a group of potential buyers:
obtaining the number of tickets and price zone of the tickets that the seller desires to sell;
displaying to the seller any offers to buy currently posted by potential buyers of the number of tickets in the price zone of the tickets that the seller desires to sell, the display including a specified selling price, a second transaction fee, and a courier pickup fee corresponding to each offer to buy; and
determining from the seller whether the seller wishes to accept one of the currently posted offers to buy or to post an offer to sell the tickets that the seller desires to sell at a price specified by the seller, and
if the seller wishes to accept one of the currently posted offers to buy, then charging a courier pickup fee to a credit card account of the seller for picking up the tickets, or
if the seller wishes to post an offer to sell the desired number of tickets at a specified price, then preauthorizing a courier pickup fee to a credit card account of the seller for picking up the tickets, the preauthorized fee to be charged upon acceptance of the offer by one of the potential buyers,
so that in both cases the purchase and sale may be completed by charging the preauthorized charge to the buyer and crediting the amount so charged to the credit card of the seller less a second transaction fee.

2. A method for using a computer to facilitate both a purchase of at least one ticket to an event by a buyer from one of a group of potential sellers and a sale of at least one ticket to an event by a seller to one of a group of potential buyers, comprising,
in the case of a purchase by a buyer from one of a group of potential sellers:
obtaining a desired number of tickets and price zone from the buyer;
displaying to the buyer any offers to sell currently posted by potential sellers of the desired number of tickets in the desired price zone, the display including a selling price for the tickets corresponding to each offer to sell;
determining from the buyer whether the buyer wishes to accept one of the currently posted offers to sell or to post an offer to buy the desired number of tickets at a specified price, and
if the buyer wishes to accept one of the currently outstanding offers to sell, then preauthorizing a charge to a credit card account of the buyer for the selling price corresponding to the accepted offer to sell, or
if the buyer wishes to post an offer to buy the desired number of tickets at a specified price, then preauthorizing a charge to a credit card account of the buyer for the specified buying price; and
in the case of a sale by a seller to one of a group of potential buyers:
obtaining the number of tickets and price zone of the tickets that the seller desires to sell;
displaying to the seller any offers to buy currently posted by potential buyers of the number of tickets in the price zone of the tickets that the seller desires to sell, the display including a specified selling price and a courier pickup fee corresponding to each offer to buy; and
determining from the seller whether the seller wishes to accept one of the currently posted offers to buy or to post an offer to sell the tickets that the seller desires to sell at a price specified by the seller, and
if the seller wishes to accept one of the currently posted offers to buy, then charging a courier pickup fee to a credit card account of the seller for picking up the tickets, or
if the seller wishes to post an offer to sell the desired number of tickets at a specified price, then preauthorizing a courier pickup fee to a credit card account of the seller for picking up the tickets, the preauthorized fee to be charged upon acceptance of the offer by one of the potential buyers,
so that in both cases the purchase and sale may be completed by charging the preauthorized charge to the buyer and crediting the amount so charged to the credit card of the seller.

3. A method for using a computer to facilitate both a purchase of at least one ticket to an event by a buyer from one of a group of potential sellers and a sale of at least one ticket to an event by a seller to one of a group of potential buyers, comprising
in the case of a purchase by a buyer from one of a group of potential sellers: obtaining a desired number of tickets and price zone from the buyer;
displaying to the buyer any offers to sell currently posted by potential sellers of the desired number of tickets in the desired price zone, the display including a selling price for the tickets corresponding to each offer to sell; and
determining from the buyer whether the buyer wishes to accept one of the currently posted offers to sell or to post an offer to buy the desired number of tickets at a specified price, and
if the buyer wishes to accept one of the currently outstanding offers to sell, then preauthorizing a charge to a credit card account of the buyer for the selling price corresponding to the accepted offer to sell, or
if the buyer wishes to post an offer to buy the desired number of tickets at a specified price, then preauthorizing a charge to a credit card account of the buyer for the specified buying price, and
in the case of a sale by a seller to one of a group of potential buyers:
obtaining the number of tickets and price zone of the tickets that the seller desires to sell;
displaying to the seller any offers to buy currently posted by potential buyers of the number of tickets in the price zone of the tickets that the seller desires to sell, the display including a specified selling price corresponding to each offer to buy; and
determining from the seller whether the seller wishes to accept one of the currently posted offers to buy or to post an offer to sell the tickets that the seller desires to sell at a price specified by the seller,
so that in both cases the purchase and sale may be completed by charging the preauthorized charge to the buyer and crediting the amount so charged to the credit card of the seller.
